(19) United States
(12) Patent Application Publication
(10) Pub. No.: US 2020/0258093 A1
(43) Pub. Date: Aug. 13, 2020

(54) COMPLIANCE STANDARDS MAPPING

(71) Applicant: HEWLETT PACKARD ENTERPRISE DEVELOPMENT LP, Houston, TX (US)

(72) Inventors: David L. Shaw, Houston, TX (US); David Graves, Palo Alto, CA (US); Fernando F. Fuentes, Plano, TX (US)

(21) Appl. No.: 16/271,353

(22) Filed: Feb. 8, 2019

(51) Int. Cl. G06Q 30/00; G06F 21/62

(52) U.S. Cl. CPC G06Q 30/018; G06F 21/6218

(57) ABSTRACT

A method includes reading a standards content into a compliance standard input processor and loading a security requirement into a compliance mapping database. The method also includes inputting a security requirement score for each of a set of security requirements for a product, receiving a request for a compliance report for the product based on the standards content, and matching a correlation between the product and the standards content. The method also includes outputting the compliance report for the product, the compliance reporting having the set of security requirements for the product and the security requirement score for the product.

### BACKGROUND

Compliance standards for various products and services are used so that such products and services comply with associated laws, rules, regulations, and policies. Compliance standards are present in various fields including, for example, cloud computing, defense, healthcare, finance, and engineering, to name just a few. Before particular products or services may be instituted, companies may determine whether the particular products or services comply with the compliance standards.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a schematic representation of a compliance standards mapping system, according to one or more examples of the disclosure.

FIG. 2 is a flowchart depicting a method for generating information about a product, according to one or more examples of the disclosure.

FIG. 3 is an example computing device with a hardware processor and accessible machine-readable instructions, according to one or more examples of the present disclosure.

FIG. 4 is a flowchart depicting a method for generating security requirements about a product, according to one or more examples of the disclosure.

FIG. 5 is an example computing device with a hardware processor and accessible machine-readable instructions, according to one or more examples of the present disclosure.

FIG. 6 is a schematic representation of a computer processing device that may be used to implement functions and processes, according to one or more examples of the present disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

As discussed above, prior to implementing particular products or services, companies may determine whether the products or services meet certain regulatory requirements. Examples of such regulatory requirements may be included in compliance standards, which define the security requirements for the implementation of such products and/or services. In order to determine whether products or services comply with certain compliance standards, individual experts review compliance standards and then compare the products or services to the requirements provided therein. The process of comparing the products or services against the compliance standards may be time consuming and costly due to the number of products and services, as well as the number of compliance standards in a particular field.

Additionally, the compliance standards change over time, so experts have to keep appraised of the changes, which may further delay the determination of whether a product or service complies with a particular compliance standard. Furthermore, a particular product or service may have to comply with more than one compliance standard. As such, multiple experts may manually review each product or service in view of one or more compliance standards, further increasing the time of the review as well as the cost.

Methods and systems disclosed herein may provide for the mapping of compliance standards to particular products and/or services. As such, when a user would like to know how a product or service measures up against a compliance standard, the user may query the mapped standards and access a report without the need to contact an expert on the compliance standard. Moreover, the user may request information about multiple compliance standards and/or multiple products and services. Rather than rely on multiple experts, the standards that are mapped to specific products and services may allow the user to receive the information relatively quickly with little associated cost.

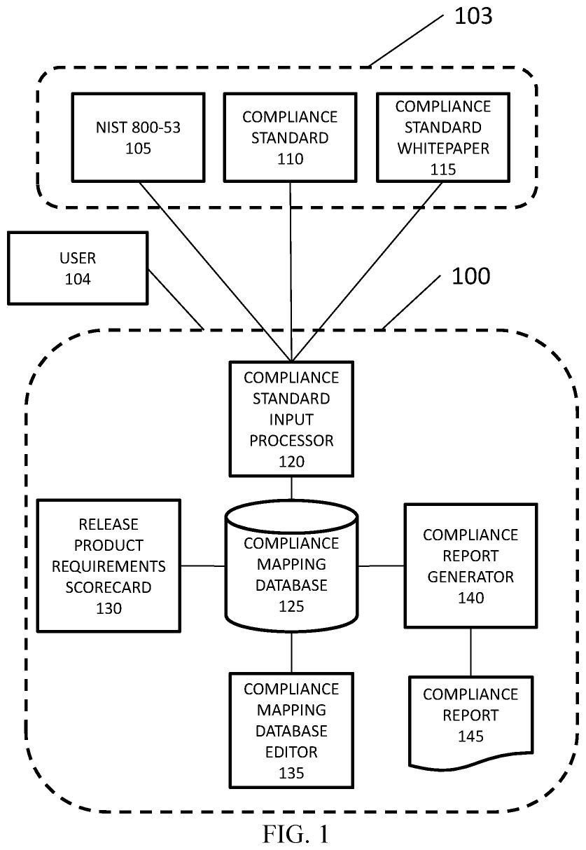

Turning now to FIG. 1, a schematic representation of a compliance standards mapping system 100, in accordance with one or more examples of the present disclosure is shown. In this implementation, compliance standards mapping system 100 may provide functionality to map a standards content 103, thereby allowing a user 104 to determine whether devices comply with standards content 103 and/or meet certain security parameters. Standards content 103 may include information in various formats. For example, standards content 103 may include text files, spreadsheets, and/or information in a machine-readable format.

Standards content 103 may include any type of content that provides standards, information about standards, and/or information about complying with standards. For example, standards content 103 may include National Institute of Standards and Technology Special. Publication 800-53 (“NIST 800-53”) 105. NIST 800-53 may provide a catalog of security controls for U.S. federal information systems. NIST 800-53 may include thousands of pages of information related to the management, operational, and technical safeguards for information systems to protect confidentiality, integrity, and availability of devices and information associated therewith. Other standards content 103 can be used, for example, payment compliance, Sarbanes-Oxley Compliance, the Payment Card Industry Data Security Standard, the Federal Information Security Management Act, the Health Insurance Portability and Accountability Act, the European Union Agency for Network and Information Security standards, the Federal Financial Institutions Examination Council standard, as well as other industry specific standards in the fields of finance, medicine, maritime, shipping, telecommunications, computing, and the like.

Standards content 103 may further include one or more compliance standards 110. Compliance standards 110 may refer to a rule or regulation, such as a specification, policy, or law with which a product may comply. There may be any number of compliance standards 110 that are used by compliance standards mapping system 100, such as compliance standards 110 that relate to technology, technology groups, groups of devices, types of devices, types of information, types of security, etc. While only one compliance standard 110 is illustrated, standards content 103 may include tens, hundreds, or even thousands of compliance standards 110.

Standards content 103 may also include a compliance standard whitepaper 115. Compliance standard whitepaper 115 may include additional information about a particular standard that is provided by a user 104 or third party. Compliance standard whitepaper 115 may thereby provide notes, revisions, analysis, or other information about one or more compliance standards 110. While only one compliance standard whitepaper 115 is illustrated, standards content 103 may include tens, hundreds, or even thousands of compliance standard whitepapers 115 that relate to one or, more compliance standards 110.

In certain implementations, standards content 103 may exclude one or more of NIST 800-53 105, compliance standard 110, and/or compliance standard whitepaper 115. In an example implementation, standards content 103 may include NIST 800-53, without any additional standards content 103. In other implementations, standards content 103 may include specific compliance standards 110 and/or compliance standard whitepapers 115, while not including NIST 800-53 105.

In operation, compliance standards mapping system 100 may receive standards content 103 through a compliance standard input processor 120. Compliance standard input processor 120 may receive standards content 103 as inputted information in an automated process, whereby the standards content 103 is inputted to compliance standards input processor 120 from an archive of information (not shown). In certain implementations, the archive of information may include a database of standards content 103 that may be updated as standards content 103 changes. In other implementations, compliance standard input processor 120 may receive information from user 104 and/or another third party. In such an implementation, user 104 or other third party manually inputs standards content 103. As such, standards content 103 may be inputted into compliance standard input processor 120 by an individual or through machine assisted processes.

Compliance standard input processor 120 may output standards content 103 to a compliance mapping database 125. Compliance mapping database 125 may include structure that allows standards content 103 to be stored and organized. Additionally, compliance mapping database 125 may include information about products, releases, solution types, security requirements, security requirement scores, implementation notes, and other information that may be used in determining product compliance with one or more standards content 103.

Products may refer to a device or group of components that when assembled result in a product that may be commercially available and/or otherwise for manufactured or for sale. Examples of products may include computing devices, storage devices, processors, memory, network devices, consumer devices, enterprise equipment, and the like. Products may also include services or a group of services. For example, a financial product may include a banking transaction, acquisition, etc. Similarly, a healthcare product may include the transmission of patient records. Thus, as used herein, the term product may refer to both physical devices as well as industry specific services.

Security requirements may refer to the functional and non-functional requirements that a product satisfies in order to achieve a specified level of security. For example, for a device, a security requirement may refer to a type of encryption, use of a password, etc.

Releases may refer to a particular model of a product. For example, the release may refer to a version of a product that is selected, based on a production time period, production date, production location, set of features, etc. As such, each product may include one or more releases.

Solution types may refer to one or more products and/or security requirements. The solutions may thus include both a product and a security requirement for the product that is implemented in a certain way. Accordingly, products and associated security requirements may be associated with multiple solution types.

Security requirements may be stored in a security requirements database (not shown) that may be operatively connected to compliance standards mapping system 100. Security requirement scores may provide a numerical score that is representative of how well a product or product solution measures up to a particular security requirement or set of security requirements.

Implementation notes may refer to additional information provided by user 104 and/or a third party. Implementation notes may allow for information to be provided to compliance mapping database 125 that may not otherwise be included in the security requirements score. For example, user 104 may not be able to provide a binary response, e.g., yes or no answer, in response to a question about a security requirement. As such, the security requirement score may not be determined without additional information. Implementation notes may thereby provide user 104 the option to add information about a product or product solution that may be used in determining whether the product or product solution meets a certain standard and/or security requirement.

Collectively, information about products, releases, solution types, security requirements, security requirement scores, implementation notes, and other information that is provided may be referred to as a set of product information. Compliance mapping database 125 may include standards content 103 and the set of product information. Such standards content 103 and the set of product information may be organized in compliance mapping database 125 so that security requirements, security requirement scores, implementation notes, etc., may be associated with particular products or solution types. When user 104 queries compliance mapping database 125 for information about a particular product, a response may be provided that takes into consideration how the product measures up to security requirements set forth by standards content 103. Because standards content 103 is mapped relative to security requirements for products, user 104 may receive a response to the inquiry in a relatively short period of time.

Compliance mapping database 125 may be operatively connected to a release product requirements scorecard 130. Release product requirements scorecard 130 may be accessed by user 104 to provide information to compliance mapping database 125 about a particular product. For example, user 104 may answer questions about a product, such as binary questions, i.e., yes/no answers, may indicate that the question is not applicable to the product, may provide answers to subjective questions, for which the options above are not accurately responsive, and/or provide a score with respect to a security requirement for a particular product. Additionally, in certain implementations, release product requirements scorecard 130 may be used to interpret information in machine-readable format, thereby providing compliance mapping database 125 information automatically.

Compliance mapping database 125 may also be operatively connected to a compliance mapping database editor 135. Compliance mapping database editor 135 may be used to update or otherwise modify information stored in compliance mapping database 125. For example, user 104 may use compliance mapping database editor 135 to provide additional information about products, releases, solution types, security requirements, security requirement scores, implementation notes, and other information stored in compliance mapping database 125.

Compliance mapping database 125 may further be operatively connected to a compliance report generator 140. Compliance report generator 140 may be used to generate a compliance report 145 for products, standards, security requirements, security requirements scores, and the like. In operation, user 104 may query compliance standards mapping system 100 for information about one or more products. Compliance report generator 140 may receive the requested information from compliance mapping database 125. Compliance report generator 140 may then format the information required by the user and output compliance report 145 including the requested information. Compliance reports 145 may be standardized, so that information contained therein is formatted in a particular way, or may be customized, so that only information requested by user 104 is included in compliance report 145.

For example, in operation, user 104 may desire information on compliance progress for one or more products. User 104 may select the products in question and desired compliance targets. After selecting the desired products and type of standards content 103, compliance report generator 140 may generate compliance report 145 illustrating security requirement scores along with corresponding security control identifiers from the selected standards content 103. Accordingly, compliance standards mapping system 100 may generate compliance reports 145 for products in order to determine how well products measure up with respect to multiple security standards as defined by standards content 103. Information contained in compliance report 145 may then be used in making decisions regarding what products to use and/or what products not to use in a particular implementation.

In certain implementations, compliance report generator 140 may collect information from compliance mapping database 125 and the information may indicate that the product queried by user 104 does not meet a threshold requirement for one or more of standards content 103. In such an example implementation, compliance report generator 140 may generate compliance report 145 including alternative products that meet the threshold requirement for the one or more standards content 103. Additionally, in certain example implementations, the alternative products may include a different release of a product, as different releases may include updates designed to comply with specific standards content 103.

A threshold requirement may refer to a minimally accepted compliance score. For example, the threshold requirement may indicate that if the product does not meet all requirements for a particular standards content 103, the product does not meet the threshold requirement. In other examples, the threshold requirement may refer to meeting a score in a range, e.g., scoring a 5 out of 10, to meet the threshold requirement.

Methods of using compliance standards mapping system 100, as well as methods of updating compliance standards mapping system 100 in response to new standards content 103 are discussed in detail below.

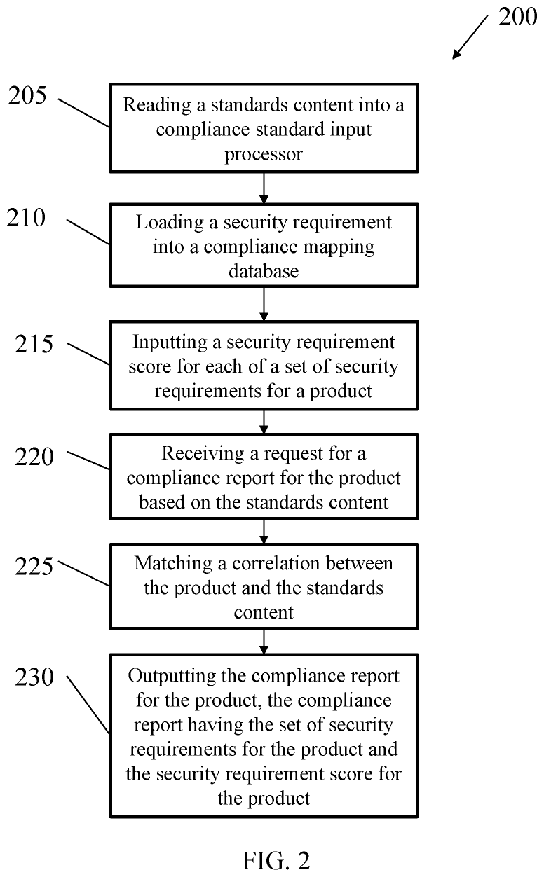

Turning to FIG. 2, a flowchart depicting a method 200 for generating information about a product, in accordance with one or more examples of the present disclosure is shown. In operation, method 200 may include reading (block 205) a standards content into a compliance standard input processor. The standards content may include any of the types of compliance standards, security standards, compliance standards whitepapers, and the like, which were discussed above in detail with respect to FIG. 1. The standards content may be provided by users or third parties and may be updated upon publication of new revisions. Additionally, users or third parties may manually load the standards content into the compliance standard input processor, or the compliance standard input processor may be provided information in a machine-readable format. When the standards content is provided in a machine-readable format, compliance standard input processor may automatically process the information without further intervention from a user or third party.

In operation, method 200 may further include loading (block 210) a security requirement into a compliance mapping database. Security requirements may include requirements as set forth in the standards content. Accordingly, the compliance standard input processor may read information from the security content then load the security requirements set forth in the security content into the compliance mapping database. In one implementation, the compliance standard input processor may read the content of NIST 800-53 and load the security requirements in NIST 800-53 into compliance mapping database. In other implementations, the compliance standard input processor may read the content of a compliance standard and/or a compliance standard whitepaper into the compliance mapping database.

In operation, method 200 may further include inputting (block 215) a security requirement score for each of a set of security requirements for a product. Various products may be stored within the compliance mapping database. Each product in the compliance mapping database may include one or more security requirements that define the set of security requirements for the product. Accordingly, a user may access a release product requirements scorecard editor and provide information about how well a product performs respective to security requirements as defined by the standards content.

For example, in one implementation, a user may access the release product requirements scorecard editor in order to answer questions about a particular product. The user may indicate that the product does not meet a certain security requirement and/or may indicate that the product does meet a certain security requirement. The user may thereby provide information about the product for multiple security requirements. Additionally, the user may provide other information, such as implementation notes, to indicate how a product measures up against certain security requirements. The user may indicate that a product does not fail to meet the security requirement, but only meets the requirements in certain implementations. The user may also indicate that certain questions are not relevant to a product based on the security requirements. Users may also update security requirement scores as standards content changes or as product and/or product releases change.

In operation, method 200 may further include receiving (block 220) a request for a compliance report for the product based on the standards content. A user may want to know whether a particular product meets specific security requirements for a given implementation. The user may thus access a compliance report generator and request certain information. In an example implementation, the user may access the compliance report generator through a graphical user interface, however, in other implementations, the user may access compliance report generator through other mechanisms that allow the user to request information from compliance mapping database.

In an example implementation, the user may request information about one or more products. The user may specify that they would like information about how the one or more products score with respect to a particular standards content or subset of standards content. For example, the user may request information about how a computing device measures up to a subset of security requirements as set forth in NIST 800-53.

In operation, method 200 may further include matching (block 225) a correlation between the product and the standards content. When the user requests information, the compliance report generator may query the information from compliance mapping database. Compliance mapping database may thereby provide information with respect to how the product measures up to the requested standards content. Following the example above, the compliance mapping database may provide information about how the computing device measures up against NIST 800-53 and/or subsets thereof. The information provided may include the product, releases, solution types, security requirements, security requirement scores, implementation notes, and other information that may be requested by the user.

In operation, method 200 may further include outputting (block 230) the compliance report for the product, the compliance report having the set of security requirements for the product and the security requirement score for the product. With the requested information, the user may know whether a product meets or exceeds specific security requirements as set forth by the selected standards content. The user may then use the information to select specific products or groups of products for implementation.

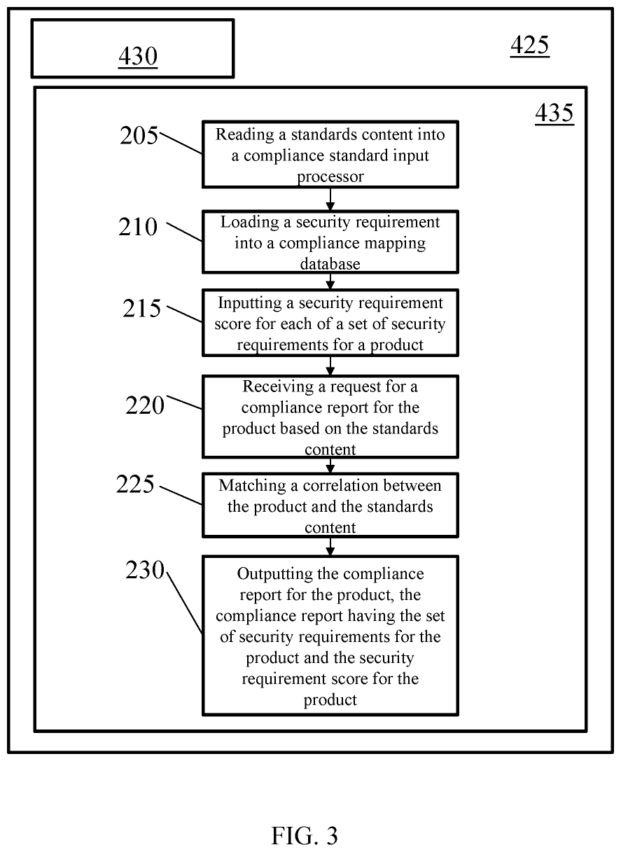

Turning to FIG. 3, an example computing, device with a hardware processor and accessible machine-readable instructions is shown in accordance with one or more examples of the present disclosure. FIG. 3 provides an example computing device 425, with a hardware processor 430, and accessible machine-readable instructions stored on a machine-readable medium 435 for generating information about a product as discussed above with respect to one or more disclosed example implementations. FIG. 3 illustrates computing device 425 configured to perform the flow described in blocks 205, 210, 215, 220, 225, and 230 discussed in detail with respect to FIG. 2. However, computing device 425 may also be configured to perform the flow of other methods, techniques, functions, or processes described in this disclosure.

A machine-readable storage medium, such as 435 of FIG. 3, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

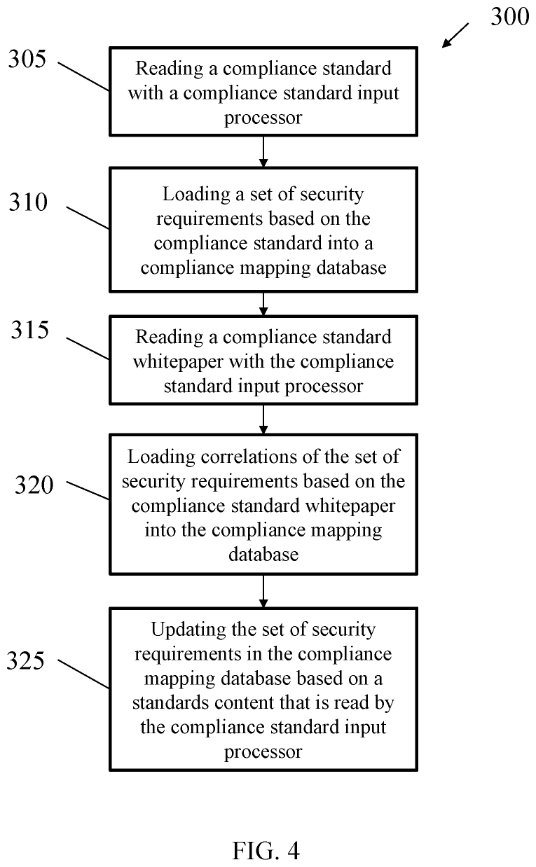

Turning to FIG. 4, a flowchart depicting a method 300 for generating security requirements about a product, in accordance with one or more examples of the present disclosure is shown. In operation, method 300 may include reading (block 305) a compliance standard with a compliance standard input processor. The compliance standard input processor may receive information from any number of compliance standards including, but not limited to NIST 800-53. Also, depending on the implementation, compliance standard input processor may receive information from any number of compliance standards and may read such compliance standards either linearly or in batch form.

In operation, method 300 may further include loading (block 310) a set of security requirements based on the compliance standard into a compliance mapping database. The security requirements may be based on the compliance standards that are inputted into the compliance standard input processor. As such, compliance standard input processor may process the compliance standards to extract the security requirements. The security requirements may then be associated with a specific compliance standard within the compliance mapping database.

In operation, method 300 may further include reading (block 315) a compliance standard whitepaper with the compliance standard input processor. As explained above with respect to reading the compliance standard, the compliance standard whitepaper may be inputted into the compliance standard input processor. The compliance standard input processor may then determine with which compliance standard the compliance standard whitepaper is associated.

In operation, method 300 may further include loading (block 320) correlations of the set of security requirements based on the compliance standard whitepaper into the compliance mapping database. The compliance standard whitepaper may include additional information, including the interpretation of users of the applicability of specific compliance standards. As such, compliance mapping database may include not only the security requirements defined by a particular compliance standard but may also include how the compliance standards are interpreted or otherwise applied. This additional information may thereby allow users to access a repository of compliance standards that includes how the compliance standards are interpreted and/or otherwise applied.

In operation, method 300 may further include updating the set of security requirements in the compliance mapping database based on a standards content that is read by the compliance standard input processor. Compliance standards, compliance standard whitepaper, and other types of standards content may be modified in response to regulatory or other types of changes. As such, compliance standard input processor may be provided additional, new, or modified standards content as the content provided thereto changes. Accordingly, compliance mapping database may include up to date security requirements.

In certain implementations, users may have implementation notes on one or more security requirements. In such a situation, editing an implementation note on a security requirement of the set of security requirements through a compliance mapping database editor may occur. As such, additional information about security requirements and/or how security products relate to particular products or solutions may be included within the compliance mapping database.

In still other implementations, the set of security requirements may be correlated to one or more products. The correlations may be saved in compliance mapping database. When a user requests information about how a product measures up to a compliance standard and associated security requirements, the user may query the database, and the information is readily available.

In other implementations, a score for one or more security requirements in the set of security requirements for a product may be entered into the compliance mapping database through a release product requirements scorecard editor. As such, a user may provide scores for particular products showing how the products measure up against security standards.

In other implementations, the information provided in compliance mapping database may be used to generate a compliance report based on a product and a set of security requirements. The report may be requested by a user through, for example, a compliance report generator. As discussed above, the report may be customized to fit the information requested by the user or may include standardized templates that include commonly requested information. In certain implementations, the compliance report may be based on a product solution and the set of security requirements. As such, multiple products that form a product solution may be requested by a user, and compliance mapping database may provide information about how the components together measure up against specific security requirements.

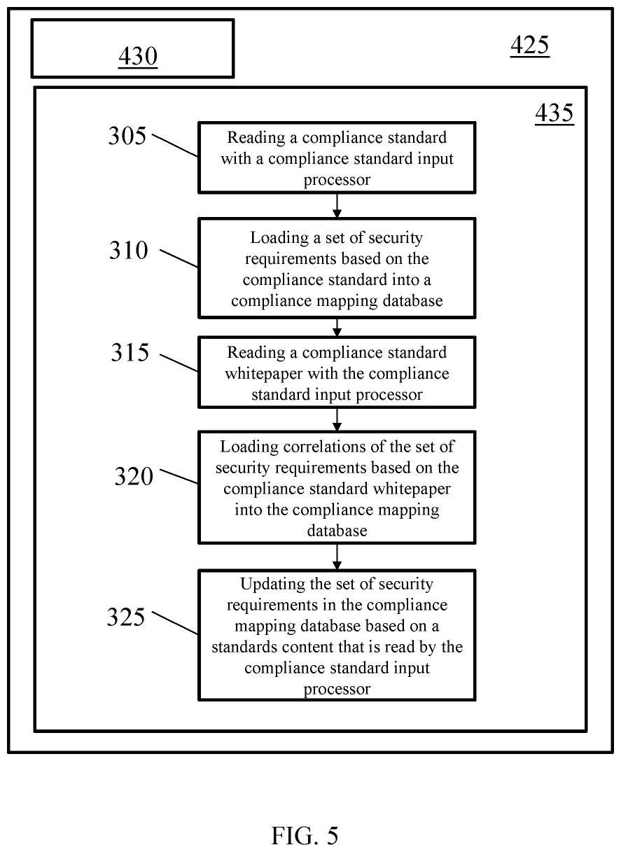

Turning now to FIG. 5, an example computing device with a hardware processor and accessible machine-readable instructions is shown in accordance with one or more examples of the present disclosure. FIG. 5 provides similar structural components discussed above with respect to FIG. 3, and as such, for purposes of clarity, only the differences in the figures will be discussed herein. FIG. 5 provides an example computing device 425, with a hardware processor 430, and accessible machine-readable instructions stored on a machine-readable medium 435 for managing data as discussed above with respect to one or more disclosed example implementations. FIG. 5 illustrates computing device 425 configured to perform the flow described in blocks 305, 310, 315, 320, and 325, discussed in detail with respect to FIG. 4.

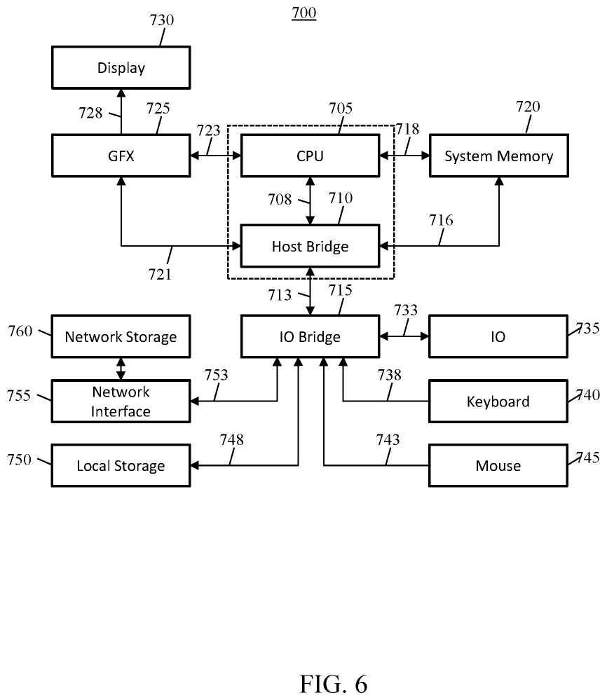

Turning, now to FIG. 6, a schematic representation of a computing system 700 that may be used to implement functions and processes in accordance with one or more examples of the present disclosure is shown. FIG. 6 illustrates computing system 700 that may be used to implement the systems, methods, and processes of this disclosure. For example, computing system 700 illustrated in FIG. 6 could represent a client device or a physical server device and include either hardware or virtual processor(s) depending on the level of abstraction of the computing device. In some instances (without abstraction), computing system 700 and its elements, as shown in FIG. 6, each relate to physical hardware. Alternatively, in some instances one, more, or all of the elements could be implemented using emulators or virtual machines as levels of abstraction. In any case, no matter how many levels of abstraction away from the physical hardware, computing system 700 at its lowest level may be implemented on physical hardware. In one implementation, computing system 700 may allow a subscriber to remotely access one or more data centers. Similarly, the management tool used by the subscriber may include a software solution that runs on such a computing system 700.

FIG. 6 shows a computing system 700 in accordance with one or more examples of the present, disclosure. Computing system 700 may be used to implement aspects of the present disclosure, such as an orchestrator, a gateway manager, a cloud monitor, a local storage, a cloud-based storage, or any other device that may be used implementing the systems and methods for managing data discussed herein. Computing system 700 may include one or more central processing units (singular “CPU” or plural “CPUs”) 705 disposed on one or more printed circuit boards (not otherwise shown). Each of the one or more CPUs 705 may be a single-core processor (not independently illustrated) or a multi-core processor (not independently illustrated). Multi-core processors typically include a plurality of processor cores (not shown) disposed on the same physical die (not shown) or a plurality of processor cores (not shown) disposed on multiple die (not shown) that, are collectively disposed within the same mechanical package (not shown). Computing system 700 may include one or more core logic devices such as, for example, host bridge 710 and input/output (“IO”) bridge 715.

CPU 705 may include an interface 708 to host bridge 710, an interface 718 to system memory 720, and an interface 723 to one or more IO devices, such as, for example, graphics processing unit (“GPU”) 725. GPU 725 may include one or more graphics processor cores (not independently shown) and an interface 728 to display 730. In certain embodiments, CPU 705 may integrate the functionality of GPU 725 and interface directly (not shown) with display 730. Host bridge 710 may include an interface 708 to CPU 705, an interface 713 to 10 bridge 715, for embodiments where CPU 705 does not include interface 718 to system memory 720, an interface 716 to system memory 720, and for embodiments where CPU 705 does not include integrated GPU 725 or interface 723 to GPU 725, an interface 721 to GPU 725. One of ordinary skill in the art will recognize that CPU 705 and host bridge 710 may be integrated, in whole or in part, to reduce chip count, motherboard footprint, thermal design power, and power consumption. 10 bridge 715 may include an interface 713 to host bridge 710, one or more interfaces 733 to one or more IO expansion devices 735, an interface 738 to keyboard 740, an interface 743 to mouse 745, an interface 748 to one or more local storage devices 750, and an interface 753 to one or more network interface devices 755.

Each local storage device 750 may be a solid-state memory device, a solid-state memory device array, a hard disk drive, a hard disk drive array, or any other non-transitory computer readable medium. Each network interface device 755 may provide one or more network interfaces including, for example, Ethernet, Fibre Channel, WiMAX, Wi-Fi, Bluetooth or any other network protocol suitable to facilitate networked communications. Computing system 700 may include one or more network-attached storage devices 760 in addition to, or instead of, one or more local storage devices 750. Network-attached storage device 760 may be a solid-state memory device, a solid-state memory device array, a hard disk drive, a hard disk drive array, or any other non-transitory computer readable medium. Network-attached storage device 760 may or may not be collocated with computing system 700 and may be accessible to computing system 700 via one or more network interfaces provided by one or more network interface devices 755.

One of ordinary skill in the art will recognize that computing system 700 may include one or more application specific integrated circuits (“ASICs”) that are configured to perform a certain function, such as, for example, hashing (not shown), in a more efficient manner. The one or more ASICs may interface directly with an interface of CPU 705, host bridge 710, or 10 bridge 715. Alternatively, an application-specific computing system (not shown), sometimes referred to as mining systems, may be reduced to only those components necessary to perform the desired function, such as hashing via one or more hashing ASICs, to reduce chip count, motherboard footprint, thermal design power, and power consumption. As such, one of ordinary skill in the art will recognize that the one or more CPUs 705, host bridge 710, 10 bridge 715, or ASICs or various subsets, super-sets, or combinations of functions or features thereof, may be integrated, in whole or in part, or distributed among various devices in a way that may vary based on an application, design, or form factor in accordance with one or more example embodiments. As such, the description of computing system 700 is merely exemplary and not intended to limit the type, kind, or configuration of components that constitute a computing system suitable for performing computing operations, including, but not limited to, hashing functions. Additionally, one of ordinary skill in the art will recognize that computing system 700, an application specific computing system (not shown), or combination thereof, may be disposed in a standalone, desktop, server, or rack mountable form factor.

One of ordinary skill in the art will recognize that computing system 700 may be a cloud-based server, a server, a workstation, a desktop, a laptop, a netbook, a tablet, a smartphone, a mobile device, and/or any other type of computing system in accordance with one or more example embodiments.

Advantages of one or more example embodiments may include one or more of the following:

In one or more examples, systems and methods disclosed herein may be used to automate compliance standard searching, thereby providing users access to information about product compliance without manually parsing each individual standard that may or may not be applicable to a particular product.

In one or more examples, systems and methods disclosed herein may be used to generate compliance reports that provide users substantially real-time compliance information regarding product compliance.

In one or more examples, systems and methods disclosed herein may be used to increase the speed and efficiency with which product compliance requirements may be determined.

In one or more examples, systems and methods disclosed herein may be used to provide reliable product compliance scoring based on a collection of standards content.

In one or more examples, systems and methods disclosed herein may be used to generate a compliance report that includes a compliance score based on one or more standards content related to one or more products.

In one or more examples, systems and methods disclosed herein may be used to automatically update product compliance as standards content changes.

In one or more examples, systems and methods disclosed herein may be used to suggest alternative products when a requested product does not meet a required standards content.

In one or more examples, systems and methods disclosed herein may be used to provide both qualitative information on standards content, e.g., implementation notes and/or user inputted information, and quantitative information on standards content, e.g., scores, as the standards content related to particular products.

Not all embodiments will necessarily manifest all these advantages. To the extent that various embodiments may manifest one or more of these advantages, not all of them will do so to the same degree.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method comprising:
reading a standards content into a compliance standard input processor;
loading a security requirement into a compliance mapping database;
inputting a security requirement score for each of a set of security requirements for a product;
receiving a request for a compliance report for the product based on the standards content;
matching a correlation between the product and the standards content; and
outputting the compliance report for the product, the compliance report having the set of security requirements for the product and the security requirement score for the product.

2. The method of claim 1, further comprising adding an additional standards content to the compliance standard input processor.

3. The method of claim 1, wherein the standards content comprises a compliance standard and a compliance standard whitepaper.

4. The method of claim 1, further comprising inputting an implementation note for the security requirement, the implementation note providing a set of information used to determine the security requirement score for the product.

5. The method of claim 1, wherein the compliance report further comprises a release for the product, the release for the product defining a security requirement score for the product.

6. The method of claim 1, wherein the compliance report further comprises a security requirement.

7. The method of claim 1, wherein the compliance report further comprises a product solution.

8. The method of claim 7, further comprising matching correlations between the product solution and the standards content.

9. A system comprising:
a compliance standard input processor for receiving a standards content;
a compliance mapping database connected to the compliance standard input processor, the compliance mapping data database comprising the standards content and a set of information about a product;
a release product requirements scorecard editor connected to the compliance mapping database for inputting a security requirement score for a security requirement for the product;
a compliance mapping database editor for adding a correlation for the security requirement; and
a compliance report generator connected to the compliance mapping database for outputting a compliance report for the product.

10. The system of claim 9, wherein the compliance mapping database editor further comprises an implementation note for the security requirement.

11. The system of claim 9, wherein the compliance report comprises the security requirement for the product and the security requirement score for the product.

12. The system of claim 11, wherein the compliance report further comprises a release and a product solution.

13. The system of claim 9, wherein the standards content comprises a compliance standard, a compliance standard whitepaper, and a National Institute of Standards Technology 800-53.

14. A non-transitory computer readable medium comprising computer executable instructions stored thereon that, when executed by one or more processing units in a source system, cause the one or more processing units to:
read a compliance standard with a compliance standard input processor;
load a set of security requirements based on the standards content into a compliance mapping database;
read a compliance standard whitepaper with the compliance standard input processor;
load correlations of the set of security requirements based on the compliance standard whitepaper into the compliance mapping database; and
update the set of security requirements in the compliance mapping database based on an additional standards content that is read by the compliance standard input processor.

15. The non-transitory computer readable medium of claim 14, further comprising instructions stored thereon that, when executed by the one or more processing units, cause the one or more processing units to update the set of security requirements in the compliance mapping database based on an additional compliance standard whitepaper that is read by the compliance standard input processor.

16. The non-transitory computer readable medium of claim 14, further comprising instructions stored thereon that, when executed by the one or more processing units, cause the one or more processing units to edit an implementation note on one security requirement of the set of security requirements through a compliance mapping database editor.

17. The non-transitory computer readable medium of claim 14, further comprising instructions stored thereon that, when executed by the one or more processing units, cause the one or more processing units to correlate a plurality of products to the set of security requirements.

18. The non-transitory computer readable medium of claim 17, further comprising instructions stored thereon that, when executed by the one or more processing units, cause the one or more processing units to enter a score for a security requirement in the set of security requirements for the product.

19. The non-transitory computer readable medium of claim 17, further comprising instructions stored thereon that, when executed by the one or more processing units, cause the one or more processing units to generate a compliance report based on the product and the set of security requirements.

20. The non-transitory computer readable medium of claim 17, further comprising instructions stored thereon that, when executed by the one or more processing units, cause the one or more processing units to generate a compliance report based on a product solution and the set of security requirements.
